(19) United States
(12) Patent Application Publication
(10) Pub. No.: US 2012/0225491 A1
(43) Pub. Date: Sep. 6, 2012

(54) PORTABLE DETECTION DEVICES AND METHODS FOR DETECTION OF BIOMARKERS AND OTHER ANALYTES

(76) Inventors: Ayal Ram, Tel Aviv (IL); Tal Shapira, Bney Dror (IL)

(21) Appl. No.: 13/340,243

(22) Filed: Dec. 29, 2011

Related U.S. Application Data
(60) Provisional application No. 61/428,702, filed on Dec. 30, 2010.
(60) Provisional application No. 61/448,909, filed on Mar. 3, 2011.

(51) Int. Cl. G01N 21/64; B82Y 15/00

(52) U.S. Cl. 436/501; 422/69; 977/774; 977/902

(57) ABSTRACT

A detection device and method for detecting one or more analytes of interest in a test sample are provided. Some embodiments use analyte-specific binding partners that are conjugated to quantum dots (Qdots) for use in detecting the presence and/or quantity of the analytes of interest in a test sample. FRET based methods may to used enhance the quantum dot (Qdot) signal through complexing of the quantum dots with lanthanide chelates, such as terbium. Some embodiments of the invention provide a novel disposable testing device that contains, all in one, the components necessary for carrying out the novel assay detection system of the invention. The disposable testing device may be used at home, for example, to detect and quantitate, at ultrasensitive levels, multiple analytes in a biological sample with no requirement for professional assistance.

### CROSS-REFERENCE TO RELATED APPLICATIONS

This application claims the benefit of provisional application No. 61/428,702, filed Dec. 30, 2010, and provisional application No. 61/448,909, filed Mar. 3, 2011. The entire contents of both of these prior provisional applications are expressly incorporated herein by reference.

### BACKGROUND OF THE INVENTION

A number of different methods and devices have been designed for detecting and measuring the quantities of biomarkers in a biological sample for applications such as clinical analysis of bodily fluids. Such methods have often employed immunoassays, such as sandwich assays, for detection of the analyte of interest. The tests typically are conducted in a clinical lab with professional assistance, requiring reading equipment in the clinical lab, and the process can be lengthy and/or expensive.

There exists a need for improved systems and methods for diagnostic detection of analytes such as biomarkers in fluids.

### SUMMARY OF THE INVENTION

The present invention provides novel diagnostic detection devices and methods that may be used for ultrasensitive detection and quantification of analytes of interest in a test sample. Some embodiments described herein provide diagnostic detection devices and methods that may be used for the detection and quantification of analytes in a bodily fluid through the use of bioassays. Such bioassays may include, for example, immunoassays such as sandwich immunoassays that may be used for detection of analytes of interest. Still further, for detection of nucleic acids of interest within a test sample, nucleic acid hybridization assays may be used. As used herein, the term “analyte” generally refers to a substance, such as a biomarker, to be detected in a sample. Such analytes include, for example, proteins, polypeptides, nucleic acid molecules, antibodies, glycoproteins, lipids, hormones, toxins and pathogenic microorganisms. The detection of such analytes in a sample may indicate the presence of, or predisposition to, a disease or disorder. Such diseases or disorders include, for example, genetic disorders, cancers, metabolic diseases or disorders, and infectious diseases. In some instances, the detection of an analyte of interest may indicate the presence of a toxic substance in a test sample.

The detection device of some embodiments of the invention employs analyte-specific binding partners that can be conjugated to quantum dots (Qdots) for use in detecting the presence and/or quantity of the analytes of interest in a test sample. As described in detail below, Qdots have a unique property know as tunability, wherein the physical size of the Qdot determines the wavelength of emitted light. This property can be advantageously utilized to detect multiple analytes of interest in a single test sample. Förster Resonance Energy Transfer (FRET) based methods can also be used wherein the Qdots are complexed with a lanthanide chelate, such as terbium.

Such complexing of the Qdot with a lanthanide chelate, such as terbium, may be accomplished through the use of biotin/streptavidin labeled reagents. For example, Qdots may be coated with or associated with biotin molecules while terbium may be complexed with streptavidin. Because of the affinity between biotin and strepavidin, the Qdot and terbium are brought into close proximity thereby resulting in enhancement of the Qdot signal. Such reagents are commercially available (Invitrogen).

In accordance with one aspect, some embodiments described herein provide a small, portable detection device that is capable of taking a sample, analyzing the sample, and providing the results of the analysis. The results may be displayed on a display that is part of the device, such as an OLED display, or the device may transmit the results, for example via a wireless signal, for display on an external display device such as a computer or smartphone.

A small, portable detection device as described herein may be a handheld device. In some embodiments, for example, the detection device may have a length and width approximately the size of a typical credit card, for example a length of approximately 90 mm and a width of approximately 60 mm, with a thickness of approximately 10 mm or less or 5 mm or less or 1 mm or less. In some other embodiments, for example, the detection device may have a length of approximately 180 mm or less and a width of approximately 110 mm or less, with a thickness of approximately 20 mm or less. Other sizes are possible.

In accordance with another aspect, some embodiments described herein provide a detection device including an inlet where a fluid sample enters the device, a reaction chamber, and a detection chamber. The device may further include means for transporting the sample from the reaction chamber to the detection chamber.

In accordance with another aspect, some embodiments described herein provide a detection device capable of drawing a sample of whole blood using one or more microneedles. In such embodiments, the sample may be drawn directly from the patient into the device, with no preparation of the blood needed before entering the device.

In accordance with another aspect, some embodiments described herein provide a detection device capable of detecting analytes in fluid at picomolar concentration levels (10⁻⁹ mol/m³) or sub-picomolar concentration levels. In some embodiments, for example, the detection device is capable of detecting a single molecule in 15 microliters of whole blood.

In accordance with another aspect, some embodiments described herein provide a detection device capable of detecting multiple analytes at one time from a single sample. For example, some embodiments are capable of detecting and quantifying multiple analytes from a single sample of fluid such as whole blood.

In accordance with another aspect, some embodiments described herein provide a detection device capable of taking a sample, analyzing the sample, and providing the results in a short period of time. In some embodiments, the detection device is capable of taking a sample, analyzing the sample, and providing the results in 10 minutes or less, for example in 4 to 8 minutes. Other periods of time are possible.

In accordance with another aspect, some embodiments described herein provide a small, portable detection device that is capable of being fully operated, from taking the sample through displaying the results, without the need for secondary analytical equipment such as the analyzing equipment typically used in clinical labs. Some embodiments described herein provide a detection device that is capable of being fully operated, from taking the sample through displaying the results, without the need for physician assistance; such devices may be fully operated by the patient or another person assisting the patient. Some embodiments described herein provide a detection device that is disposable.

In some embodiments of the invention, a method for detecting one or more analytes in a test sample comprises the following steps:
(i) supplying a test sample to a reaction chamber, wherein said reaction chamber contains any buffer and primary analyte binding partners necessary for detection and/or quantitation of the analytes of interest and wherein the binding partner is capable of complexing with a detectable Qdot;
(ii) allowing for the required incubation period for recognition and binding of analytes to their primary binding partners to form an analyte/binding partner/Qdot complex;
(iii) transferring the reaction mixture to a detection chamber wherein the detection chamber contains a secondary binding reagent, referred to as a capture reagent, immobilized on a surface of the detection chamber;
(iv) allowing for the required incubation period for recognition and binding of the analyte/binding partner/Qdot complex to the capture reagent;
(v) washing the detection chamber with a buffer to clear the detection chamber of un-reacted components of the assay; and
(vi) detecting the presence and/or quantity of the bound analyte/binding partner/Qdot complexes.

In some specific embodiments of the invention, the test sample is a fluid sample, such as a bodily fluid sample. The test sample may also comprise a water sample, a food or beverage product sample, or a pharmaceutical composition or component thereof.

In some specific embodiments of the invention, the primary binding partner is an antibody, or fragment thereof. Additional primary binding partners include but are not limited to, polypeptides, ligands, receptors, or nucleic acid molecules.

For use in some embodiments of the present invention, the capture reagent is a reagent that preferentially binds to the analyte/binding partner/Qdot complex of interest. Such reagents include, for example, antibodies, or fragments thereof, polypeptides, ligands, receptors, or nucleic acid molecules. Further, the analyte/binding partner/Qdot complex may comprise a lanthanide chelate, such as terbium.

Some embodiments of the present invention comprise a disposable testing device that contains, all in one, (i) an inlet port where the liquid test sample enters into the device (ii) a reaction chamber, (iii) a detection chamber for detecting and/or quantitating analyte/Qdot complexes, wherein the reaction chamber and the detection chamber are connected via a horizontal flow path; and (iv) a means for detecting and quantitating the analyte/Qdot complexes. Such means may include, for example, components for the use of a constant UV OLED, UV LED, OLED or LED detection method or a pulsed excitation (UV laser, UV OLED or UV LED) and time-gated detection FRET based method. For detection of Qdots, excitation may be in the range of 300 to 600 nm, preferably between 300-490 nm. For Tb FRET detection, excitation may be in the 300-360 nm range, preferably in the 330-345 nm range.

The testing device of the invention may comprise means for collecting and transferring a bodily fluid sample to the reaction chamber. Such means may include, for example, the use of spring loaded microneedle arrays which can be used to collect blood. Additionally, some embodiments of the invention may further comprise one or more of the following components: a chamber containing a wash buffer connected to the detection chamber, a sponge designed to absorb the buffer wash, and time dissolved membranes between one or more chambers of the device. For example, time dissolved membranes may be placed between the reaction chamber and the detection chamber and/or between the detection chamber and the absorbing sponge. Additionally, or alternatively, a micro-pump may be utilized to move the test sample and/or buffer wash through the device.

Some embodiments of the present invention provide a means for carrying out medical diagnostic tests, for pathogen and toxicology screening and for detecting the presence of disease markers without the need for professional assistance.

### BRIEF DESCRIPTION OF THE DRAWINGS

FIG. 1 provides an illustration of an assay for biomarker detection using FRET analysis detection according to some embodiments of the disclosure, i.e. an antibody mediated heterogeneous immunoassay.

FIG. 2 provides an illustration of an assay for biomarker detection using FRET analysis detection according to some embodiments of the disclosure, i.e. a Biotin-Streptavidin mediated heterogeneous immunoassay.

FIG. 3 provides an illustration of a microfluidic chip according to one embodiment of the invention.

FIG. 4 provides an illustration of a device according to one embodiment of the invention, showing the microfluidic chip of FIG. 3 with an electronics chip including a photodetector system.

FIG. 5 provides a cross section illustration of the detection chamber of the microfluidic chip of FIG. 3 in a detecting position relative to the photodetection portion of the electronics chip of FIG. 4.

FIG. 6 provides a cross section illustration of a portion of a device according to another embodiment of the invention, showing a detection chamber of a microfluidic chip in a detecting position between two electronics chips.

FIG. 7 provides an illustration of a casing bottom and casing top.

### DETAILED DESCRIPTION

The present invention provides novel diagnostic detection devices and methods that may be used for ultrasensitive detection and quantification of analytes of interest in a test sample.

Some embodiments described herein provide diagnostic detection devices and methods that may be used for the detection and quantification of analytes in a bodily fluid through the use of bioassays.

Some embodiments described herein provide portable, stand-alone, disposable devices, as well as corresponding methods, for the in vitro analysis and quantification of multiple analytes in fluids, such as blood, saliva or other bodily fluids, using quantum dot conjugates for the capture and detection of analytes. As stated above, the term “analyte” generally refers to a substance, such as a biomarker, to be detected in a sample. The term “analyte” as used herein refers to any chemical, biochemical or biological entity to be detected in the sample, such as a molecule, compound, protein, virus, polypeptide, hormone, antibody, nucleic acid, toxin, microorganism, microparticle, organelle or cell, in a sample. Analytes may comprise organic or inorganic substances. Analytes may further comprise drugs, explosives or impurities. As used herein, the term “biomarker” refers to an analyte in a biological sample, the detection of which is correlated with the presence of, or predisposition to, a disease, disorder or physiological condition.

Some embodiments described herein are directed to devices and methods that utilize one or more approaches as described herein for the extraction of a minimal volume of bodily fluid such as whole blood using a minimally-invasive microneedle or microneedle array. Some of the embodiments of the present disclosure may comprise one or more of the following: a single-step approach wherein the process, from blood extraction to results read-out, does not require professional assistance; an all-in-one disposable diagnostic device wherein all components and systems for diagnostics are included and a secondary result reader is not required; a disposable diagnostic device that uses quantum dots as the reporter for analyte presence; a disposable diagnostic device to offer quantitative multiplexed detection of analytes; and a disposable diagnostic device that uses time-gated FRET detection of biomarkers.

### 1. The Assay Detection System

As used herein, the term “test sample” generally refers to a material believed to possibly contain one or more analytes of interest.

The test sample, believed to possibly contain one or more analytes of interest, may comprise or be derived from a biological source such as a bodily fluid, including for example, blood, saliva, milk, mucous, urine, etc. Besides bodily fluids, other samples that may be tested include water samples and food and beverages products that may be monitored for toxins and/or contaminating pathogenic microorganisms. Additionally, a test sample may comprise a pharmaceutical composition for use in quality control to ensure the identity and/or purity of a particular pharmaceutical composition.

Routine methods well known by those of skill in the art may be used for deriving or obtaining a test sample from a biological source. In some embodiments of the invention, the detection device provides a means for directly collecting and transferring a test sample from a subject to the detection device. Specifically, the detection device may utilize a microneedle or one or more microneedle arrays designed to transfer blood from the test subject to a reaction chamber via capillary action and/or surface tension.

A test sample can be obtained and delivered through an inlet port of the device where it may then be transferred via capillary action to the reaction chamber of the device. In one example, the reaction chamber is the site of initiation of the performance of a bioassay. Such bioassays are designed to detect one or more analytes of interest in a test sample, the presence of which is correlated to a specific disease or predisposition to a disease. The presence of the analytes of interest can function as a warning to a subject, or a healthcare professional, that a disease state is present or may develop in the future. In addition to diagnostics in human subjects, the methods and compositions of the invention may also have veterinary uses for diagnosing diseases in animals. Depending on the disease, the analyte to be targeted by the bioassay may be a protein or a nucleic acid such as DNA or RNA. The bioassays will be designed so as to selectively detect the intended target biomolecule.

In some non-limiting embodiments of the invention, the bioassays may be used to detect genetic disorders caused by abnormalities in a subject's genes. Such genetic disorders may result in a predisposition to cancer. For example, a woman's risk of developing breast and/or ovarian cancer is greatly increased if she inherits a deleterious BRCA1 or BRCA2 mutation. In such instances, the analytes of interest are nucleic acid molecules, such as DNA or RNA. A number of cardiac markers may also serve as target analytes for evaluation of heart function. Such markers include for example, LDH, albumin, ischemia-modified C-reactive protein, B-natriuretic peptide, fibrinogen and homocysteine, creatine kinase-MB (CK-MB) and troponin. A number of biomarkers are also know to be associated with liver disease and may be target analytes for evaluation of liver function. Such proteins include aspartate aminotransferase, serum glutamic oxaloacetic transaminase, alkaline phosphatase (ALP), gamma-glutamyl transferase (GGT), and bilirubin.

The concentration of steroids, hormones and drugs such as methotrexate present in biological fluid may also be used as indicators of several diseases and pathological conditions. Diagnostically important molecules like hormones, or cancer markers such as acid carcinoembroynic antigen and PSA may also serve as analyte targets. These biologically important molecules have been widely accepted as the effective indicators of disease. For example, the amount of serum PSA can increase as carcinomas of the prostate develop and mature. Elevated PSA levels in serum have been used to aid in the diagnosis and monitoring of prostate cancer. Similarly, diagnosis of various infectious diseases may be based on the detection of antigen such as hepatitis, malaria or detection of antibodies in cases of diseases like AIDS. The assay system of the invention may also be utilized to detect specific strains of bacteria, such as methicillin-resistant Staphylococcus aureus, to allow more accurate antibiotic treatment.

The detection assay system in some embodiments of the invention can utilize various types of bioassays for detection and/or quantification of the multiple analytes of interest. Such bioassays include, for example, immunoassays or nucleic acid hybridization assays. In such bioassays, the reaction mixture contains a number of components including, for example, binding reagents. A binding reagent as used herein is a compound that binds preferentially to an analyte of interest with a desired specificity. Generally, the specificity is such that the binding reagent preferentially binds to the analyte of interest rather than other analytes present in a sample. For purposes of at least some embodiments of the present disclosure, the term “binding reagent” as used herein refers to any biological, chemical, or biochemical entity, such as a compound, that binds to an analyte. Suitable binding reagents include, but are not limited to, amino acids, peptides, nucleic acids, antibody preparations (e.g. antibody fragments, chemically modified antibodies), carbohydrates, sugars, lipids, steroids, drugs, vitamins, cofactors, organic molecules, and combinations thereof. The nucleic acid based binding partner can be DNA, or RNA.

Binding reagents for use in the assay detection system in some embodiments of the invention can be primary or secondary binding reagents. As used herein the primary binding reagent is a binding reagent that is specific for the analyte of interest. The primary binding reagent and analyte form a complex referred to herein as an “analyte/binding reagent complex.” The secondary binding reagent, also referred to as the capture reagent, is specific for the analyte/binding reagent complex or analyte/binding reagent/quantum dot complex and is used to detect and quantitate the analytes present in a sample. In some embodiments of the invention, the capture reagent may be immobilized on the surface of a detection chamber as detailed below.

In some embodiments of the invention, the primary binding reagents that bind specifically to an analyte of interest are coupled to Qdots to facilitate subsequent detection and/or quantification of the analyte in the test sample (binding agent/Qdots complex). Qdots have a unique property known as tunability, wherein the physical size of the Qdots determines the wavelength of emitted light. In some embodiments of the present invention, this property can be advantageously utilized to detect multiple analytes in a single sample. For example, differentially sized Qdots, which emit distinctive detectable signals, may be coupled to specific primary binding reagents such that the detection and quantification of multiple analytes in a sample can be easily achieved. The use of Qdots offers a significant advantage because of their ability to produce a very bright emission thereby permitting the detection of small amounts of analytes of interest.

Qdots that may be used in some embodiments of the invention may comprise an emitting semiconductor core, a passivating shell, and a coating for attaching reagents to the surface. For use in the bioassays of the invention, water soluble Qdots may be used. Qdots that may be used in the practice of the invention may comprise various semiconductor materials such as, for example, CdS, CdSe, CdTe, CdTe/ZnS or CdSe/ZnS. Further, examples of Qdots that may be used in the present invention include those that emit light at wavelengths of between 525-800. In some embodiments, the Qdots include an inorganic Cadmium-Selenium (CdSe) core, with a Zinc-Sulfide (ZnS) shell. The core and shell may be covered by a polymer coating for bio-compatibility and stability. These are relatively large particles ranging from 10 to 20 nm diameter. The size of the particle can also determine the spectral properties of the Qdots. Qdots suitable for some embodiments are available (e.g., Invitrogen's Q-Dots) in up to eight different colors—suitable for multiplexing (simultaneous determination of the concentrations of multiple biomarkers).

The optical properties of Qdots according to some embodiments include one or more of brighter luminescence (high extinction coefficients and quantum yield), narrow emission spectra, and very broad excitation spectra. These characteristics allow for very low cross-talk (interference) between the different analyte complexes when multiplexing the detection, while using only a single excitation source. Thus, in some embodiments, the use of more than one Qdot as an energy transfer (ET) acceptor in one and the same sample (multiplexing) for analyte detection, especially for biological and biochemical applications, is provided. The measurement of different analytes within one sample may be of special interest due to economic reasons such as less time, less space, less sample preparation, and less sample constituent volume, all leading to saving time and money. Important fields such as self-testing, point-of-care and high-throughput screening can significantly benefit from the invention.

Qdots, because of their chemical properties, may also offer a longer shelf life as opposed to traditionally used fluorescent dyes and are not affected by photo-bleaching. The emission spectra of some standard, off-the-shelf, Qdots is narrow enough for eight colors to be measured at the same time, and, therefore, the technology currently allows up to eight biomarkers to be measured simultaneously.

The Qdots to be used in some embodiments of the invention may further comprise a functional coating that can be conjugated with molecules that drive the binding of the Qdot to a specific analyte of interest. Such molecules include, for example, antibodies, nucleic acids, ligands, receptors, or binding partners found in natural protein/protein interactions. The large surface area afforded by the Qdots allows simultaneous conjugation of many biomolecules to a single Qdot. By combining different binding reagents with Qdots of different sizes, with different emission wavelengths, it is possible to detect multiple analytes of interest in a single test sample. This advantageously allows one to detect and quantitate multiple analytes in a single test. Methods for production of Qdots are routine and well known to those of skill in the art, and Qdots are commercially available (Invitrogen).

In some embodiments, the detection device and method of the invention may use Förster Resonance Energy Transfer (FRET) between Terbium complexes (Tb) (donor) and Quantum Dots (acceptor). To a large extent this method eliminates background noise, and enables the possibility of multiplexed detection. Such FRET based assays rely on the energy transfer from donor (Lanthanide complexes—specifically Terbium complexes) to acceptor Qdots. Optical excitation of the donor is transferred to luminescence of the acceptor. The system is extremely sensitive to donor-acceptor distance wherein the light intensity of FRET measurement is detected at a distance between the donor-acceptor of about 1 to 20 nm.

Accordingly in some embodiments of the invention, FRET based methods may be used for detection of the analyte/Qdot complex. In a standard FRET assay, when the fluorophores in a suitable pair of fluorophores are brought into close proximity to one another, excitation of the first flurophore (the donor) results in energy transfer to the second flurophore (the acceptor). The energy transfer is detected by an increase in the fluorescence emission of the acceptor and a decrease in flourescent emission of the donor. For some embodiments of the present invention, Qdots are complexed with a lanthanide chelate, such as terbium, that acts as a donor species while the Qdot acts as an acceptor species. Lanthanide chelates are advantageous in that their excited-state lifetime lasts a millisecond or longer, thereby greatly reducing interference from background fluorescence or light scattering.

In some embodiments, lanthanide complexes (LCs) with long luminescence lifetimes are used as ET donors. Other molecules or particles are also possible ET donors. Simultaneously several different Qdots, e.g., a plurality (e.g., 2, 3, 4, 5, 6, 7, 8, or more) of different Qdots, may be provided within one sample. See e.g., WO 2010/084015, incorporated herein by reference in its entirety.

In some embodiments, the lanthanide chelate donor is terbium. Terbium (Tb) complexes show extremely long luminescence lifetimes in the range of milli-seconds (ms). This long lifetime luminescence energy is transferred to FRET sensitized Qdot emission. As background signals decay much faster (by a few orders of magnitude), the time-gated detection with a delay of several micro-seconds allows for virtually background-free detection. This translates to excellent sensitivity when detecting biomarkers in the sub-picomolar (pM) concentration range.

The terbium chelate (donor) may be attached directly to the Qdot (acceptor), or, alternatively, the terbium may be attached indirectly through a biotin mediated association. For example, a Qdot can be coated or associated with one or more biotin molecules. Terbium chelates can be labeled with streptavidin. When the biotin labeled Qdot is contacted with the streptavidin labeled terbium chelate, a complex is formed between the Qdot and the terbium chelate due to the affinity of biotin for streptavidin. Terbium labeled biotin binding reagents are available commercially, for example, from Invitrogen.

In some embodiments of the invention, the terbium chelate may be attached directly or indirectly to the primary binding reagent. Complex formation between the analyte and the binding reagent, followed or accompanied by binding of the Qdot to the formed complex brings the Qdot and the terbium chelate in close proximity to one another.

A short-pulsed UV laser, UV OLED or UV LED may be used to radiate the sample at a single wavelength. The short laser pulse results in a much faster decay of any background signal. The laser excites the Terbium complexes (Tb) which transfer the energy to luminescence of the quantum dots (FRET). Tb exhibits long-lasting luminescence in the milli-second range, resulting in the emission of light in short pulses by the quantum dots which appear later, after the background signal has almost totally decayed. With time-gated detection of a micro-second delay, and virtually background-free detection, the quantum dot signal can be measured at extremely high sensitivity.

In some embodiments of the invention, the bioassay is an immunoassay that is based on the use of polyclonal or monoclonal antibodies, recombinant antibodies or antibody fragments. Such immunoassays are designed to measure the presence and/or quantity of one or more analytes of interest in a test sample that frequently contains a complex mixture of substances. Such immunoassays depend on the fact that the analyte of interest is known to undergo a unique immune reaction with a second substance, i.e., a binding reagent. Immunoassays can be carried out using either the analyte or the antibody in order to test for the other member of the analyte/antibody pair.

In some embodiments of the invention, the immunoassay may be a sandwich immunoassay. In a sandwich immunoassay, one antibody is associated with a Qdot and a second antibody is coupled to a solid support. An analyte of interest having separate binding sites for the first and second antibodies is exposed to the antibody coupled to the Qdot such that the analyte binds to that antibody. The first antibody/analyte complex is then added to the second antibody that is coupled to the solid support. Thus, the amount of the analyte present in a sample is a function of the amount of detected label bound to the second antibody bound to the support.

Some immunoassays for use in the present invention may include the following components: a primary antibody (Ab1) bound to Qdots and a Lanthanide complex (Ln) as well as one or more analytes of interest (antigen (Ag)) via a first epitope of the antigen and second antibody (Ab2) bound to the antigen via a second epitope of the antigen. The immunoassay may include a washing step to remove any unbound Qdots-Ab1-Ln conjugates that have not been bound to the antigen.

According to some embodiments, the method of preparing an immunoassay for detection and measurement of biomarkers in a bodily fluid may include one or more of the following steps, and in some embodiments a plurality of the following steps, and still further in some embodiments all of the following steps:
(i) obtaining a fixed volume of a bodily fluid (e.g., whole blood);
(ii) in a reaction chamber, mixing the fixed volume of the bodily fluid with a buffer containing anti-coagulants and Qdots conjugated to a primary antibody (“Ab1”) or Qdots-primary-antibody-Lanthanide-complexes, where Lanthanide complexes (“Ln”) include Terbium complexes;
(iii) binding of one or more analytes (antigen (“Ag”)) to the Qdots-Ab1-Ln conjugate to form Qdots-Ab 1-Ln-Ag conjugate using a first antigen epitope;
(iv) transferring the Qdots-Ab1-Ln-Ag conjugate to a detection chamber;
(v) mixing the Qdots-Ab1-Ln-Ag conjugate with secondary antibodies that are immobilized on the detection chamber's surface to form Qdots-Ab1-Ln-Ag-Ab2, where Ab2 binds to a second epitope of the antigen to form a sandwich assay;
(vi) performing a wash of the detection chamber to remove any excess/unbound Qdots-Ab1-Ln conjugates (may be absorbed into a sponge), thereby leaving the detection chamber with only bound Qdots-Ab1-Ln-Ag-Ab2 conjugates;
(vii) exhibiting the Qdots-Ab 1-Ln-Ag-Ab2 conjugates to a photodector system thereby exciting Ln complexes (donor) that excite Qdots (acceptor); and
(viii) detecting light emitted by the Qdots to determine the presence of biomarkers.

In some embodiments, the immunoassay captures the antigen by a specific antibody, and then detects the antigen concentration by the binding of a second specific antibody to another site on the antigen to which is attached a signaling molecule. To that end, in some embodiments, the immunoassay produces a detectable signal for the presence of antigen molecules which will be directly proportional to their concentration in the sample. Accordingly, in some embodiments, the immunoassay is designed so that the signal molecule attached to the second antibody will be activated by its binding to the complex of the first antibody with the antigen, and not by an unattached antibody. In some immunoassays according to the present disclosure, the signaling unit is an enzyme attached to the antibody which catalyzes a chemical reaction that produces light and can be measured via a photo-detector. Other assays, according to some embodiments, use reporters (signals) such as fluorescent dyes, radioactive elements, gold particles, chemi-luminescent substrates, and others.

Heterogeneous immunoassays according to some embodiments of the present disclosure include a number of steps to complete, and are executable via multiple methods. In one type of reaction, the first step is the binding, in the sample solution in a reaction chamber, between a certain region of the analyte (antigen) and the primary binding reagent (antibody (AB)-reporter/label conjugate). After an incubation period, the solution is introduced to a second chamber in which there is a surface bound secondary set of antibodies which recognize a different region of the antigen (the epitope) for a second binding step. A second incubation period allows binding between the initial complex, formed in the first step, to the secondary set of antibodies, creating a larger complex containing antigen bound to a primary antibody-reporter/label, and also bound to the surface attached secondary antibody. The formation of this “sandwich” of the antigen bound to two different antibodies results in the immobilization of the entire complex to the surface of the second chamber. A wash step clears the excess amount of unbound primary antibody-reporter/label or other residues of biological fluids (e.g. blood, urine, etc.) that might interfere with detection of signal. The concentration of the antigen can now be determined by activation of the reporter/label luminescence, the intensity of which is directly correlated to the amount of antigen in the sample which has bound to the two antibodies.

In some embodiments of the present disclosure, a heterogeneous immunoassay involves capturing the analyte (antigen) with a primary binding reagent (antibody) that is covalently linked to a Qdot. In addition, a lanthanide complex (Lc) e.g. a Terbium complex (Tb), may also be covalently attached to the antibody or Qdot. In the first step, the antigen molecule is captured by the antibody on the Qdot. The solution may then be transferred to a detection chamber which contains the secondary set of surface-attached secondary binding reagents (antibodies (Ab)). A complex is formed between (i) the primary antibody-Qdot-Lanthanide complex, (ii) the antigen and (iii) the second antibody. A wash step may then be performed to remove any unbound primary antibody-Qdot-Lanthanide complex, and then the sample is ready for quantification via FRET analysis and multiplexed detection.

In other embodiments of the invention, the immunoassay used for the diagnostic devices includes having the sandwich complex formed in one (the first) step, using both sets of antibodies in the same reaction. The analyte(s) (antigens) may react and bind with one set of antibodies covalently-linked to the Qdot and lanthanide complex. The antigens may also react with a second set of antibodies which are, in turn, covalently linked to a ligand molecule such as Biotin, HIS-tag, etc. The complex formed, Biotin-Ab-antigen-Ab-Qdot-Lc, may then be transferred to a second chamber with a receptor, such as streptavidin, nickel-beads, etc., bound to the surface of the chamber, which preferably specifically recognizes and binds the ligand molecule (Biotin, HIS-tag, etc.) with very high affinity and thus immobilizes the entire complex to the surface of the chamber. After the wash step, which may be used to remove any unbound primary antibody-Qdot-Lanthanide complex, the sample is ready for quantification via FRET analysis and multiplexed detection. In some embodiments, it may be possible to reverse the location of the receptor-ligand interaction and have the receptor (such as streptavidin) bound to the antibody and the ligand (such as Biotin) bound to the surface.

In addition to immunoassays, nucleic acid hybridization assays may be used to detect the presence of a nucleic acid analyte of interest. Specifically, the primary binding reagent may comprise a polynucleotide that specifically hybridizes to an analyte of interest comprising a target polynucleotide (analyte). Said primary binding agent may be covalently-linked to a Qdot and lanthanide complex. A polynucleotide probe may be a cDNA corresponding to a specific RNA of interest, genomic DNA, or a synthetic oligonucleotide designed to specifically hybridize to the target analyte. The analyte of interest detected through hybridization may be genomic, cDNA or RNA. The specific hybridization probe preferentially hybridizes to the target nucleic acid. Optimal hybridization conditions will depend on the sequence content and length and may be determined by one of skill in the art. (Ausubel F. M. et al., eds., 1989, Current Protocols in Molecular Biology, Vol. I, Green Publishing Associates, Inc., and John Wiley & sons, Inc., New York, at p. 2.10.3).

DNA detection may used, for example, to indicate and/or quantify the presence of bacterial infection, in which the probe recognizes and binds specific bacterial DNA sequences allowing the unique identification of the bacteria and thus defining the treatment required to eliminate the specific cause of the infection or to indicate and/or give early warning of genetic defects defining the possibility of disease (pre-symptomatic diagnostics) allowing effective preventative treatment.

The diagnostic system of some embodiments of the invention provides a means for directly detecting and measuring the presence of Qdots in a sample. Such means include the use of a UV OLED, UV LED detection method or OLED, LED detection method or pulse excitation (UV laser, UV OLED or UV LED) and time-gated detection for a FRET based method. The light source may be a backlight or may be positioned on the same side as the photodector(s). Known technology which may be used in one or more embodiments of the disclosure include, but is not limited to, the following: photodetectors or other opto-electronics, micro-lenses for focusing of light emission, spring-loaded light filtration wheels, other light wavelength filtration media, disposable Power-Paper™ organic battery, LCD/OLED screen, logic chips for data conversion and calculations, UV pulsed laser, or continuous-wave laser as excitation sources.

Detection methods include, but are not limited to, those methods wherein: (i) a pulsed UV laser, UV OLED or UV LED excites Terbium complexes attached to multiple different conjugates of multicolored quantum dots each corresponding to a different biomarker; and (ii) the terbium complexes excite quantum dots via Forster resonance energy transfer (FRET). Quantum dots emit light pulses in the micro to nano-second range, which is measured by the photodetector in time-gated manner. The photodetector signal voltage may then be converted to a digital signal by a logics chip and displayed on the OLED/LCD screen on the front of the device and/or transferred wirelessly to computer. A logics chip may be employed here to allow nanosecond analytical to digital conversion of data.

### 2. The Testing Device

The present invention provides a disposable testing device for detection of analytes of interest in a test sample. A diagnostic device according to some embodiments of the present invention allows for a single-use rapid test for the detection of multiple (one or more) analytes in a biological sample (e.g., a blood sample). The assay device comprises a hollow casing constructed of moisture-impervious solid material, such as a plastics material, which houses the components for the reaction and detection steps. The casing for the assay device may be constructed of, for example, cyclic olefin copolymer (COC), polycarbonate (PC) or acrylonitrile butadiene styrene (ABS). The casing may contain, for example, a microfluidics chip that is partitioned into two or more different chambers, for example, a reaction chamber and a detection chamber.

The device further comprises a means for transfer of a test sample to the reaction chamber. For example, the device may have a hydrophilic inlet port to allow the test sample to enter the casing automatically by capillary force. Further the device may contain a hydrophilic measurement channel trailing the inlet port that has a volume precisely equal to the desired volume of the test sample which ensures that the correct volume of sample has been collected before the sample is moved to the reaction chamber. Additionally, the flow of the test sample can also be made possible by providing a negative/suction pressure created by a micropump.

Such a diagnostic device according to some embodiments may include a microfluidic channel structure for the flow transport of a biological sample from an inlet port to a reaction chamber. The diagnostic device, in some embodiments, may include means for carrying out blood analyses in which a biological sample is conveyed by means of a channel structure from an inlet port to at least one reaction chamber. An automatic flow transport, for example, may be achieved by the channel structure having a wholly or partially capillary geometry.

The diagnostic device according to some embodiments, comprises a thin (e.g., 0.5 mm to 10 mm) elongate support (or casing) containing a channel structure therein for the flow transport of small sample quantities (on the order of microliters) of a biological sample to be analyzed from an inlet port to a measuring channel or chamber and/or to a reaction chamber and/or to a detection chamber. The channel structure and/or chambers can be provided on a separate component (such as a microfluidics chip) that is housed in the casing, or can be directly molded into the casing, or can be formed in the casing or a separate part by special manufacturing steps such as embossing or stamping. Some sections of the flow path may have a suitable capillary geometry for an automatic capillary-active flow transport of the test sample fluid.

In some embodiments, a microneedle or microneedle array may comprise the inlet port to draw blood from a patient. Accordingly, in some embodiments, the diagnostic device includes a spring-loaded microneedle or microneedle array and an actuator button that activates the micro-needle array and diagnostic mechanisms. Microneedle technology as used in some embodiments of the present disclosure provides a useful minimally-invasive method to sample blood. Due to their small size, microneedles can pierce skin and take minute quantities of blood with minimal impact or pain to the subject. Microneedles are small needles, typically in the range of from 1 micron to 3 mm long and from 10 nm to 1 mm in diameter at their bases, although the ranges can be wider, for instance up to 10 mm long and 2 mm at their bases. In some embodiments, the microneedles are about 10 to 100 microns (e.g., 10 to 20 microns, 10 to 30 microns, 10 to 40 microns, 10 to 50 microns, 10 to 60 microns, or 10 to 80 microns) in diameter at the tip.

The microneedles can form the inlet port of the device and a sample flow path extending from the inlet port into the body of the device. Microneedles for extraction of blood, microstructures (chambers, channels), and their fabrication are set out in the following applications (each of which is incorporated by reference in its entirety): (WO/2008/027011) Microneedles And Methods For Fabricating Microneedles; (WO/2008/036043) Needle Structures And Methods For Fabricating Needle Structures; (WO/2006/057619) Method And Apparatus For Forming Microstructures; (WO/2005/087305) Methods And Moulds For Use In Fabricating Side-Ported Microneedles; and (WO/2005/044364) Microneedles And Microneedle Fabrication.

As indicated above, the diagnostic device in accordance with some embodiments of the invention comprises a first chamber, referred to as a reaction chamber, to which blood is transferred from the inlet port. The transfer or flow of the test sample from the inlet port to the reaction chamber may be through capillary action, by a pushing force (e.g., by a flow released or pumped behind the sample by a micropump), by a suction force (e.g., by a micropump), or by another suitable fluid transport mechanism. The flow into the reaction chamber may be immediate or controlled, for example by a gate mechanism (e.g., a timed piezoelectric device). The reaction chamber is used for binding analytes of interest, as described above. The sample may be held in the reaction chamber for a suitable period of time to permit the desired binding, before the sample is transferred to the detection chamber. The reaction chamber may include a gate mechanism (e.g., a timed piezoelectric device) that allows for a required incubation period before transfer to the detection chamber.

The reaction chamber of the device comprises the components of the bioassay reaction which are to be mixed with the biological fluid sample. The total volume of the reaction chamber is determined by the desired volume of the sample to be tested, and the typical height of the chamber may range from 100 micrometers to 1000 micrometers, more specifically around 500 micrometers. The reaction chamber contains any buffers, anticoagulants (if blood is the sample fluid) and analyte binding partners necessary for detection and quantification of the analytes of interest. In some embodiments, the buffers, anticoagulants, and/or analyte binding partners, or other components for use in the reaction chamber may be held in a separate chamber and then allowed to flow into the reaction chamber, or forced into the reaction chamber, at the desired time. Possible anticoagulants include EDTA, citrate, heparin and protease inhibitors such as aprotinin, and D-phenylalanyl-L-propyl-L-arginine chloromethylketone (PPACK). The specific components of the bioassay to be included in the reaction chamber will depend on the specific types of analytes to be detected. For example, specific buffers and reagents will be required when using immunoassays for detection of polypeptides versus those buffers and reagents required when using nucleic acid hybridization assays for detection of a specific nucleic acid analyte. Certain specifications of the assay and device of the invention are determined prior to the manufacture and use of the device of the invention and will depend on the analyte of interest to be detected. For example, the components of the bioassay reaction solution and their concentrations in the reaction chamber, the conditions of the assay, the buffer solution, pH, ionic strength, temperature, incubation times, etc., are preferably predetermined by performance of conventional experiments to optimize the performance of the device for the desired application.

The assay device may further comprise a horizontal flow path leading from the reaction chamber to a detection chamber. Following incubation, the bioassay mixture reaction is transferred to a second chamber, the detection chamber, via the horizontal flow path. The transfer or flow of the test sample from the reaction chamber to the detection chamber may be through capillary action, by a pushing force (e.g., by a flow released or pumped behind the sample by a micropump), by a suction force (e.g., by a micropump), or by another suitable fluid transport mechanism. The flow into the detection chamber may be controlled, for example by a gate mechanism (e.g., a timed piezoelectric device) between the reaction chamber and the detection chamber. The detection chamber is where the analyte is to be detected and may contain a secondary binding reagent (capture reagent) immobilized on a surface of the detection chamber. In some embodiments, the capture reagent immobilized on the detection chamber's surface is capable of binding to the analyte/Qdot complex as described above. Immobilization of the capture reagent to the surface of the detection chamber can be achieved using various methods known to those of skill in the art. The capture reagent can be immobilized by covalent or non-covalent attachments.

As mentioned above, the transfer from one chamber to the next can occur by various means, for example by capillary action, by a pushing force (e.g., by a flow released or pumped behind the sample by a micropump), by a suction force (e.g., by a micropump), or by another suitable fluid transport mechanism. If achieved by capillary force, the surface energies of the reaction chamber and detection chamber may be varied to provide flow speeds that ensure the total times of the test sample residing in the chambers is within the desirable range. The surface energies of the chambers can be varied by coating surfactants with various wetting properties. If the movement is provided by a micropump, the micropump is turned on after a desirable period of time to provide the desired pressure, e.g., negative or suction pressure to suck or pull the mixture to the detection chamber. The diagnostic device may include a gate mechanism (e.g., a timed piezoelectric device) that allows for the incubation period of the above components with the secondary antibodies to occur.

In some embodiments of the invention, the device can be designed to include time dissolved membranes that control the timing of the flow into and/or out of the reaction and/or detection chambers, e.g., to allow for the required incubation periods for recognition and binding of analytes to their binding partners and/or for binding of the capture reagent to the analyte/Qdot complex. Thus, a first time dissolved membrane may be located in the device between the reaction chamber and the detection chamber. A second time dissolved membrane may be located in the device between the detection chamber and a chamber containing a buffer wash solution (which can force the fluid from the detection chamber into a waste chamber). Such membranes may comprise, for example, membranes that are hydrophilic polymers mixed with starches and polysaccharides, which disintegrate in the presence of water. The composition of the membranes can be formulated to achieve a desirable disintegration time so that a proper incubation can be carried out for the bioassays.

The detection chamber may be adapted to receive a buffer wash solution (as mentioned above) that clears the detection chamber of un-reacted components of the assay. Accordingly, the device may comprise a chamber containing a buffer wash solution. A horizontal flow path may be included in the device that leads from the buffer wash chamber to the detection chamber. The buffer wash solution may be actuated by a positive pressure from a micro-pump to flow into the detection chamber. Such a micro-pump can also provide a negative/suction pressure to move the buffer wash solution into the detection chamber and then to the waste chamber. This micro-pump may be the same micro-pump that moves the test sample into the reaction chamber.

The device may further comprise an absorbing sponge that absorbs the wash solution, leaving the detection chamber clear and containing only the captured analyte/Qdot complex. The micro-pump that moves the buffer wash solution into the detection chamber may further move the waste into the waste chamber, which can contain the absorbing sponge or other absorbent material to absorb and contain the waste.

In some embodiments of the invention, starting from the inlet port, the channel structure directs the biological sample to a reaction chamber. In the reaction chamber, the sample may be mixed with a reaction buffer containing primary binding reagent-Qdot complexes. In some embodiments, the mixed solution then flows into a second chamber, a detection chamber, that contains a secondary binding reagent, such as an antibody, immobilized to the detection chamber surface. The detection chamber is then exposed to a wash buffer to remove excess/unbound primary binding reagent-Qdot complexes. Bound primary binding reagent-Qdot complexes are then detectable.

In some embodiments, starting from the inlet port, the channel structure may direct the biological sample to a reaction chamber. In the reaction chamber, the sample may be mixed with a reaction buffer containing primary binding reagent-Qdot complexes. In some embodiments, the mixed solution then flows into a second reaction chamber that contains primary binding reagent-tag complexes. The solution may then flow into a third chamber, the detection chamber, that contains immobilized capture reagents that bind to the tag of the primary binding reagent-tag complexes. The detection chamber may then be exposed to a wash buffer to remove excess/unbound primary binding reagent-Qdot complexes. Bound primary binding reagent-Qdot complexes are then detectable. In some embodiments, the tag/capture molecules are biotin and streptavidin.

In some embodiments, the primary binding reagent-Qdot complexes comprise a ligand, Qdot, and an energy transfer (ET) donor (e.g., Tb or other Ln). In some embodiments, the primary binding reagent is an antibody (Ab), and thus the primary binding reagent-Qdot complexes may be referred to as Qdot-Ab-Ln complexes. In some embodiments, the primary binding reagent is an oligonucleotide (oligo), and thus the ligand-Qdot complexes may be referred to as Qdot-oligo-Ln complexes.

Following completion of the second reaction and the washing step, the device of the invention may be designed to include a means for detecting the bound analyte/Qdot complex. In some embodiments of the invention, a UV OLED or UV LED detection method or an OLED or LED detection method may be used. In another preferred method, pulse excitation (UV laser, UV OLED or UV LED) and time-gated detection for a FRET based method may be used. For detection methods, the following application is also incorporated by reference in its entirety: WO2010/084015 (A1) Method For Detecting An Analyte In A Sample By Multiplexing Fret Analysis And Kit.

The diagnostic device may also include a form of excitation device for detection of bound components. In some embodiments, the diagnostic device includes an excitation source and optoelectronic device. For example, the excitation source may be suitable for exciting the Ln and causing FRET with Qdots, and the opto-electronics unit may be suitable for detection of the time-gated signal created by the FRET. Known technology which may be used in one or more embodiments of the disclosure includes, but is not limited to, the following: photodetectors or other opto-electronics, micro-lenses for focusing of light emission, spring-loaded light filtration wheels, other light wavelength filtration media, disposable Power-Paper™ organic batteries, LCD/OLED screens, logic chips for data conversion and calculations, UV pulsed lasers, or continuous-wave lasers as excitation sources.

### 3. Examples

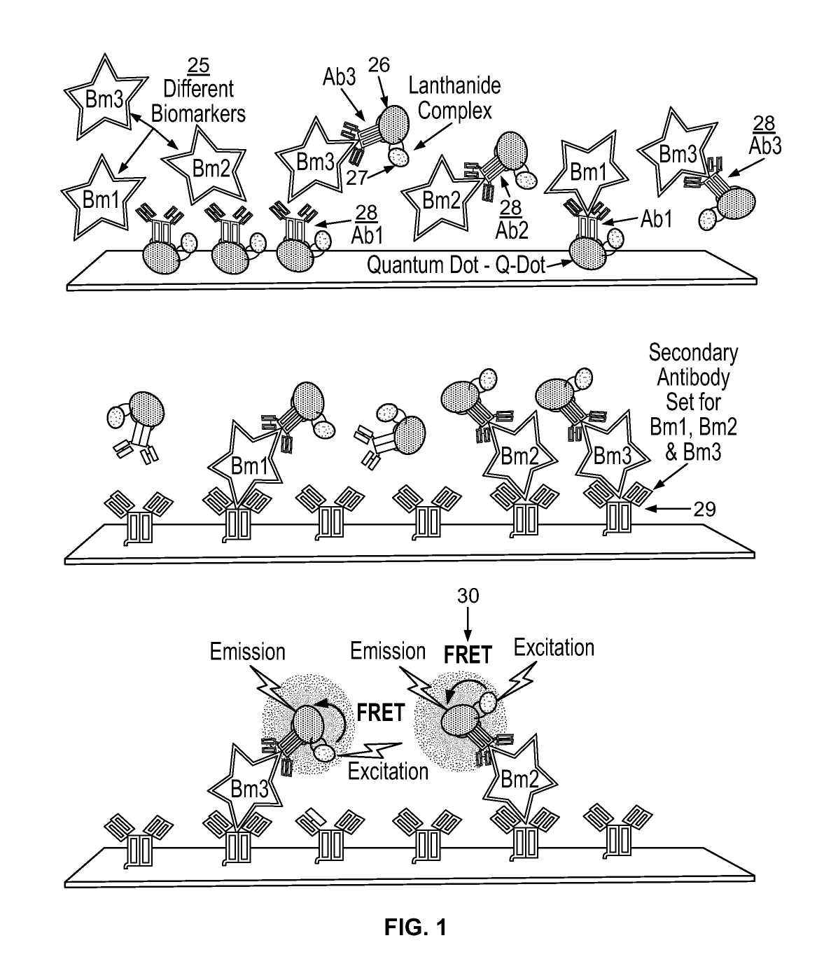

FIG. 1 provides an illustration of an assay for biomarker detection using FRET analysis detection according to some embodiments of the disclosure, i.e., an antibody mediated heterogeneous immunoassay. FIG. 1(A) depicts the components of the bioassay in the reaction chamber which includes the different biomarkers of interest (25), a first set of antibody molecules (28) specific for each of the different biomarkers of interest and Qdot (26) lanthanide chelate (27) complexes bound to the antibody molecules (28). Binding of the first set of antibodies (28) to the specific biomarkers of interest (25) results in formation of a complex between the biomarker and the Qdot/lanthanide chelate. FIG. 1(B) depicts a reaction that takes place in the detection chamber which has a second set of antibodies (29), which also recognize and bind to the biomarkers of interest (25). The second set of antibodies (29) are immobilized on a surface of the detection chamber, thereby acting as a capture reagent for the biomarker/Qdot/lanthanide complex. FIG. 1(C) depicts the photodetection analysis, in which the presence and/or quantity of biomarker present in the sample can be measured by FRET analysis.

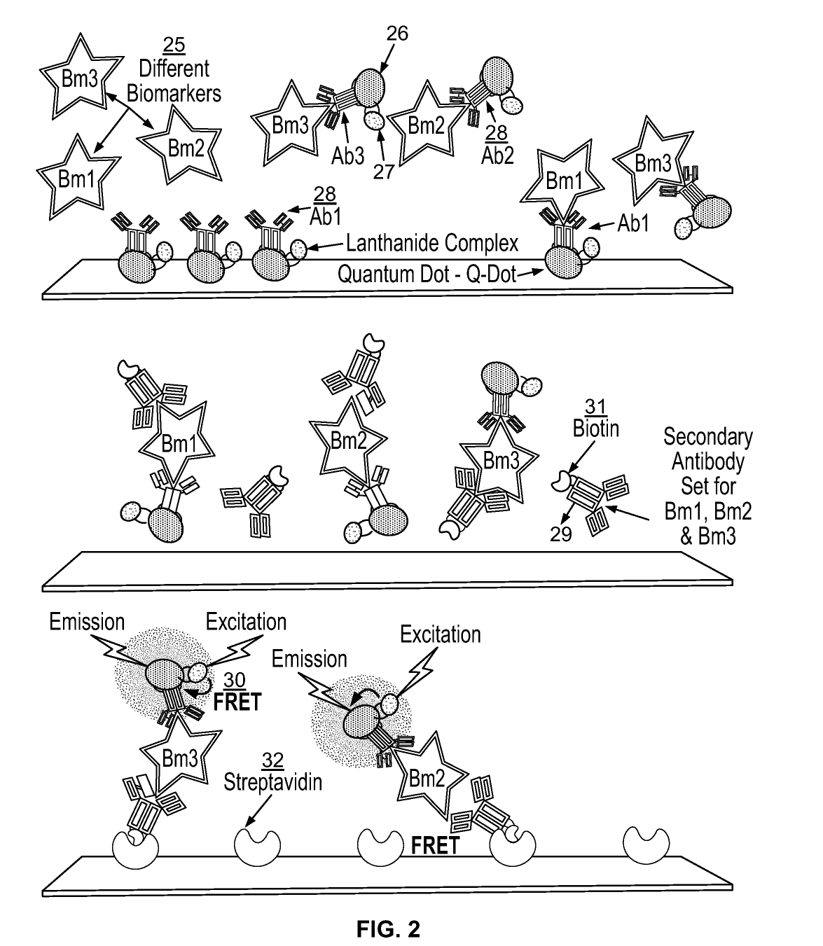

FIG. 2 provides an illustration of an assay for biomarker detection using FRET analysis detection according to some embodiments of the disclosure, i.e., a Biotin-Streptavidin mediated heterogeneous immunoassay. In FIG. 2(A), the components of the bioassay are the same as that depicted in FIG. 1(A). In FIG. 2(B), the antibodies of the secondary antibody set are not immobilized on the surface of detection chamber but have a biotin molecule (31) attached to them. In FIG. 2(C), the detection chamber is coated with streptavidin molecules and due to streptavidin's affinity for biotin, the biomarker/Qdot/lanthanide complex becomes immobilized on the surface of the detection chamber.

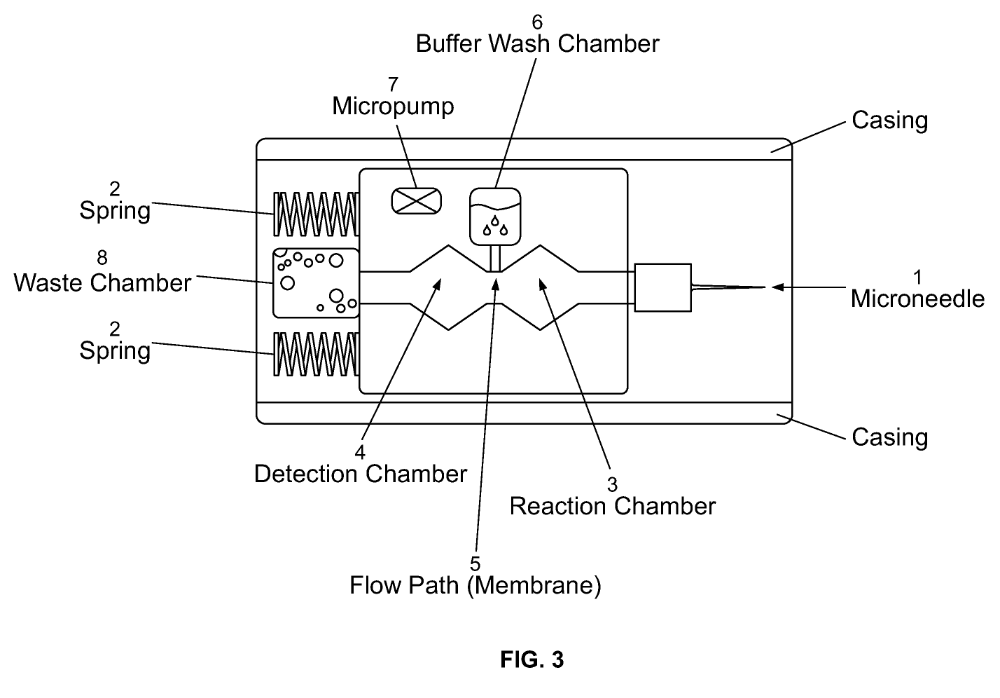

FIGS. 3, 4, 5 and 7 illustrate an embodiment of a detection device in accordance with the invention.

FIG. 3 illustrates a microfluidic chip comprising the components for fluid flow. The chip contains one or more microneedle(s) (1), a spring mechanism (2) for deployment of the microneedle(s) (1), a reaction chamber (3), a detection chamber (4) and flow path (5) connecting the reaction chamber (3) and the detection chamber (4). The device of this embodiment further comprises a buffer wash chamber (6), a micropump (7) and a waste chamber (8).

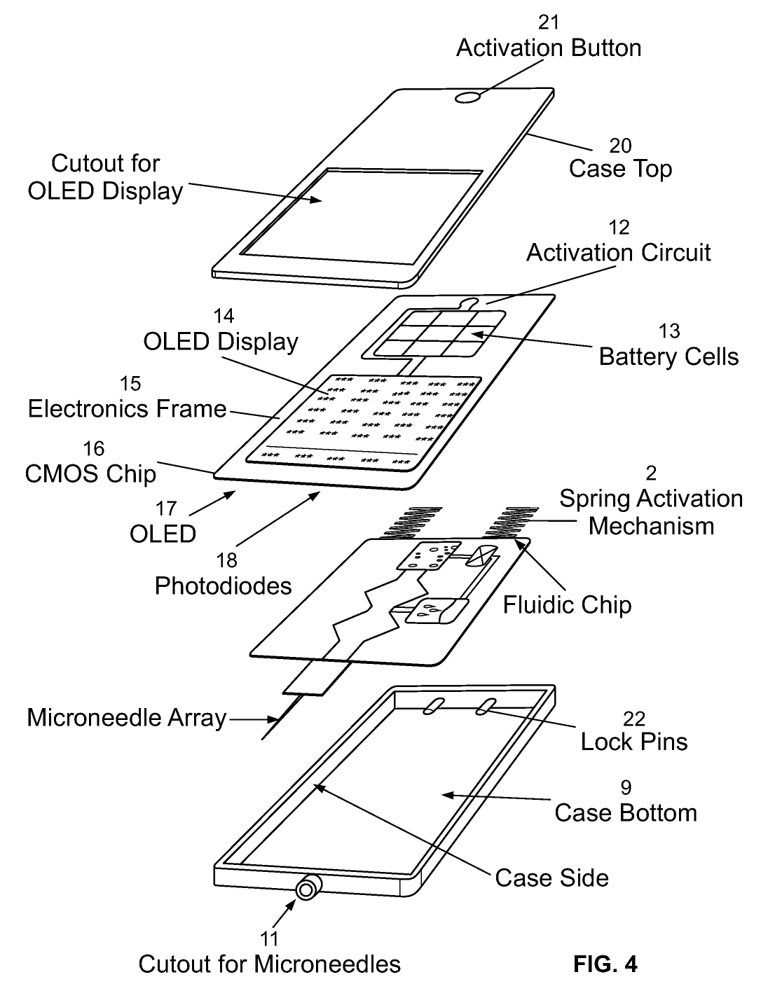

FIG. 4 illustrates an exploded view of the detection device. From bottom to top, the detection device comprises a case bottom (9), the microfluidic chip of FIG. 3, an electronics chip, and a case top (20). The case bottom (9) has sides (10), cutout (11) for the microneedle(s) (1) and lock pins (22) that function to position the microfluidics chip in order to align the detection chamber in relation to the photodiodes for detection of the Qdot signals. The electronics chip comprises a CMOS chip (16), an activation circuit (12), battery cells (13), an OLED display (14), electronics frame (15), OLED (17) and photodiodes (18). The case top (20) comprises an activation button (21).

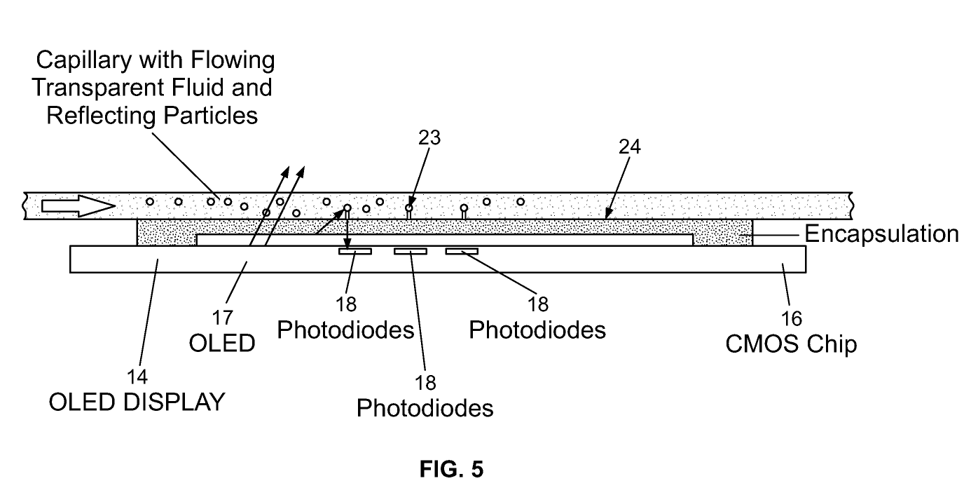

FIG. 5 illustrates the detection chamber of the microfluidic chip of FIG. 3 in a detecting position relative to the photodetection portion of the electronics chip of FIG. 4, showing OLED display (14), OLED (17) and photodiodes (18).

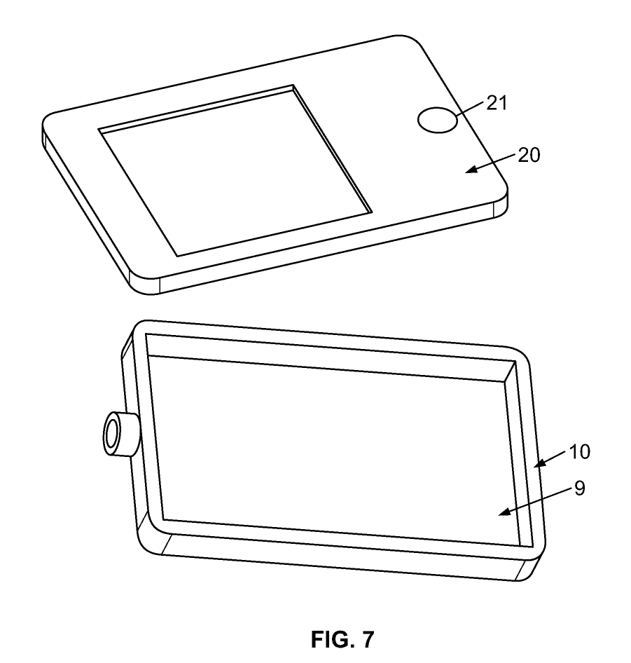

FIG. 7 illustrates the case bottom (9) with sides (10) and the case top (20) with activation button (21).

An example of one embodiment of a method of using the device as shown in FIGS. 3, 4, 5 and 7 is as follows. As received by the user, the casing is closed with the components inside the casing. The microneedle(s) (1) are retracted such that they do not extend through the cutout (11). The springs (2) are in a compressed position, and the microfluidics chip is locked by a suitable retention mechanism (not shown) as is well-known in the art.

To use the device, a user first deploys the microneedle(s), for example by pressing a needle actuator button (not shown) that releases the retention mechanism, allowing the springs (2) to force the microfluidics chip toward the side of the case with the cutout (11). The microneedles (1) then extend through the cutout (11). The user can then apply the microneedle(s) against skin to take a blood sample. In this embodiment, the blood sample is drawn into the microneedle(s) through capillary action. Additionally or alternatively, the flow of the test sample can be made possible by providing a negative/suction pressure created by micropump (7). The amount of blood drawn can be controlled by the geometry of the components. For example, when the blood is drawn, flow may not be allowed from the reaction chamber to the detection chamber. Thus, the device can hold only so much blood as can be held between the entry of the microneedle(s) up to the limit of the reaction chamber.

Once the blood sample is taken, the microfluidics chip may be retracted so as to draw the microneedles (1) back inside the casing. This may be accomplished through a suitable actuator or retraction mechanism. Alternatively, pressing the activation button (21) can activate electronics that cause the microneedles (1) to retract.

Pressing the activation button (21) can activate the electronics for the sequence of operations to occur from taking the sample through the detection of the sample and providing the results. In alternate embodiments, pressing a single button can initiate all of the steps in timed sequence, including deployment of the needle(s), retraction of the needle(s), the reaction and detection steps, and providing the results. The reaction chamber may contain the necessary components for the desired reaction chamber binding (as described above), or, alternatively, one or more of the such components may be released or forced into the reaction chamber from another location under control of the electronics activated by the activation button (21).

The sample may be held in the reaction chamber for a suitable period of time to permit the desired binding, before the sample is transferred to the detection chamber. The flow path (5) between the reaction chamber (3) and the detection chamber (4) may include a suitable gating mechanism. For example, the gating mechanism may be a membrane (as labeled in the figure) that dissolves after a certain period of time. Alternatively, the gating mechanism may be a timed piezoelectric device, actuated by the electronics after a certain period of time (determined from the time of pressing the activation button (21)).

Thus, after a certain period of time, the sample is caused or permitted to flow into the detection chamber (4). The transfer or flow of the test sample to the detection chamber may be through capillary action, by a pushing force (e.g., by a flow released or pumped behind the sample by micropump (7)), by a suction force (e.g., by micropump (7)), or by another suitable fluid transport mechanism. The detection chamber (4) contains a secondary binding reagent (capture reagent) immobilized on a surface (24) of the detection chamber (4).

The sample may be held in the detection chamber (4) for a suitable period of time to permit the desired binding. The flow path between the detection chamber (4) and the waste chamber (8) may include a suitable gating mechanism, such as a dissolving membrane or a timed piezoelectric device, under control of the electronics. In addition, the device may include a buffer wash chamber (6) that can release a buffer wash into the detection chamber (4) to wash the unbound sample into the waste chamber (8). The flow path between the buffer wash chamber (6) and the detection chamber (4) may include a suitable gating mechanism, such as a dissolving membrane or a timed piezoelectric device, under control of the electronics.

Thus, after a certain period of time, the unbound sample is caused or permitted to flow into the waste chamber (8). The transfer or flow of the unbound test sample to the waste chamber (8) may be through capillary action, by a pushing force (e.g., by a flow released or pumped behind the sample), by a suction force, or by another suitable fluid transport mechanism. An absorbing sponge or other absorbent material may be provided in the waste chamber (8).

Following completion of the binding in the detection chamber (4) and the washing step, the detection is carried out. As shown in FIG. 5, OLED (17), which may be a UV LED, is directed toward the detection chamber. The photodectors in the form of photodiodes (18) detect the signals from the bound analyte complex (23), as described above. The circuitry can convert the signal and provide a suitable output on the OLED display (14). In an alternative embodiment, the device may transmit the results, for example via a wireless signal, for display on an external display device such as a computer or smartphone.

Thus, as described above, in a specific embodiment of the present invention a single-step device/system is provided, capable of being user-initiated. The device is used by pushing a button which releases one or more spring-loaded microneedle(s). A fixed volume of blood is transferred to a reaction chamber of the device via capillary action and surface tension techniques and/or piezoelectric devices. In the reaction chamber the analyte is mixed with a buffer, which may contain anti-coagulants and Qdots conjugated (or Qdots-Ab-terbium complexes for FRET assay) to specific probes such as antibodies (Ab) or DNA oligomers that have affinity and specificity to bind targeted biomarkers such as enzymes, hormones, non-enzymatic proteins, small peptides or any constituents of biological fluids.

In this specific embodiment, a gate mechanism (e.g., timed piezoelectric device, or time-dissolved membrane) may be provided which allows the required incubation period for recognition and binding of analytes to primary binding reagents or other probes. Following incubation, the mixed solution is transferred to a detection chamber that contains a secondary set of binding reagents such as antibodies, that are referred to as capture reagents, and which are immobilized to the detection chamber surface. After a second incubation period in the detection chamber, the secondary set of Abs recognize and bind the analyte-Ab-Qdot complex via a different epitope of the biomarker (sandwich assay). A second gate mechanism (e.g., a second timed piezoelectric device) may be provided which allows for the earlier-noted second incubation period, and when activated, releases a buffer wash that clears the detection chamber of left-over blood and un-reacted/excess antibody-Qdot conjugates into an absorbing sponge in a waste chamber, leaving the detection chamber clear and containing only the complete secondary Ab-analyte-Ab-Qdot conjugate. The gate mechanism may include a timed piezoelectric device or time-dissolved membrane.

Upon completion of the reaction, bound Ab-analyte-Ab-Qdot conjugates are detected via a OLED detection method as depicted in FIG. 5.

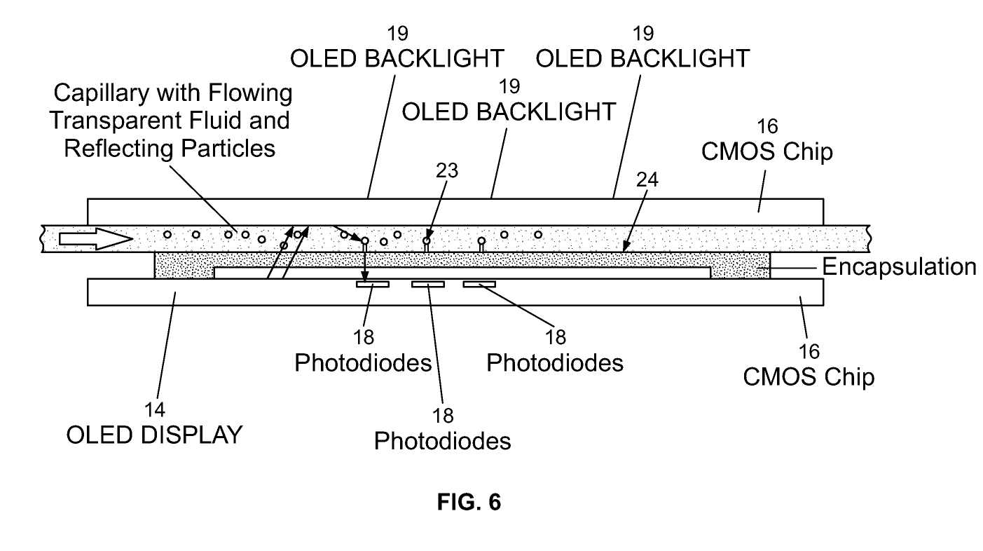

FIG. 6 illustrates of a portion of a device similar to FIG. 5 according to another embodiment of the invention, showing a detection chamber of a microfluidic chip in a detecting position between two electronics chips. The embodiment of FIG. 6 differs from that of FIG. 5 in that the OLED source is positioned on the opposite side of the detection chamber from the photodetectors (photodiodes (18)). Thus, FIG. 6 has an OLED backlight (19). The embodiment of FIG. 6 is thus constructed with electronics on both sides of the microfluidic chip. The operation of the device of FIG. 6 is similar to the embodiment of FIG. 5.

### 4. Further Details and Alternatives

Persons of ordinary skill in the art will understand from the present disclosure that the invention can provide a small, portable detection device that is capable of taking a sample, analyzing the sample, and providing the results of the analysis. The results may be displayed on a display that is part of the device, such as an OLED display, or the device may transmit the results, for example via a wireless signal or via wired links, for display on an external display device such as a computer or smartphone.

A small, portable detection device as described herein may be a handheld device. In some embodiments, for example, the detection device may have a length and width approximately the size of a typical credit card, for example a length of approximately 90 mm and a width of approximately 60 mm. In some other embodiments, for example, the detection device may have a length of approximately 180 mm or less and a width of approximately 110 mm or less. The device may have a thickness of approximately 0.5 mm to 20 mm, for example approximately 10 mm or less, approximately 5 mm or less, or approximately 1 mm or less. Other sizes are possible.

Some embodiments described herein provide a detection device capable of taking a sample, analyzing the sample, and providing the results in a short period of time. In some embodiments, the detection device is capable of taking a sample, analyzing the sample, and providing the results in 10 minutes or less, for example in 4 to 8 minutes. Other periods of time are possible.

In some embodiments, the device is capable of detecting and quantifying multiple analytes from a single sample of fluid such as whole blood. As described above, the sample may be drawn directly from the patient into the device, with no preparation of the blood needed before entering the device.

A person of ordinary skill in the art will appreciate the advantages of a small, portable detection device that is capable of being fully operated, from taking the sample through providing the results, without the need for preparation of the sample, without the need for secondary analytical equipment such as the analyzing equipment typically used in clinical labs, and without the need for physician assistance. The invention enables quick, user-operated analysis without the time and expense of additional steps, additional lab equipment, or physician assistance. The portability of the device allows the detection to be carried out in essentially any desired location.

Persons of ordinary skill in the art will understand from the disclosure of the invention described herein that numerous variations are possible within the scope of the invention. The above disclosure is meant to provide examples and is not intended to be limiting of the scope of the claims appended hereto.

What is claimed:

1. A method for detecting one or more analytes in a test sample comprising:
(i) supplying a test sample to a reaction chamber, wherein said reaction chamber contains any buffer and primary analyte binding partners necessary for detection and/or quantitation of the analytes of interest and wherein the binding partner is capable of complexing with a detectable Quantum dot;
(ii) allowing for the required incubation period for recognition and binding of analytes to their primary binding partners to form an analyte/binding partner/Quantum dot complex;
(iii) transferring the reaction mixture to a detection chamber wherein the detection chamber contains a secondary binding reagent, referred to as a capture reagent, immobilized on a surface of the detection chamber;
(iv) allowing for the required incubation period for recognition and binding of the analyte/binding partner/Quantum dot complex to the capture reagent;
(v) washing the detection chamber with a buffer to clear the detection chamber of unreacted components of the assay; and
(vi) detecting the presence and/or quantity of the bound analyte/binding partner/Quantum dot complexes.

2. The method of claim 1, wherein the test sample is a bodily fluid sample.

3. The method of claim 1, wherein the test sample is a water sample.

4. The method of claim 1, wherein the test sample is a food or beverage product sample.

5. The method of claim 1, wherein the test sample is a pharmaceutical composition or component thereof.

6. The method of claim 1, wherein the primary binding partner is an antibody, or fragment thereof.

7. The method of claim 6, wherein the Quantum dot is associated with a lanthanide chelate.

8. The method of claim 1, wherein the capture reagent is an antibody, or fragment thereof.

9. A disposable testing device comprising:
(i) an inlet port where a liquid test sample enters the device;
(ii) a reaction chamber containing components for binding an analyte of interest to Quantum dots;
(iii) a detection chamber for detecting and/or quantitating analyte/Quantum dot complexes, wherein the reaction chamber and the detection chamber are connected via a horizontal flow path; and
(iv) a means for detecting and/or quantitating the analyte/Quantum dot complexes.

10. The disposable testing device of claim 9 further comprising a means for collecting and transferring a bodily fluid sample to the reaction chamber.

11. The disposable testing device of claim 10, wherein the means for collecting and transferring a bodily fluid sample to the reaction chamber is a microneedle array.

12. The disposable testing device of claim 9, further comprising a chamber containing a buffer wash.

13. The disposable testing device of claim 12, further comprising a sponge for use in absorbing the buffer wash.

14. The disposable testing device of claim 13 further comprising two time dissolved membranes, the first being positioned between the reaction chamber and the detection chamber and the second being positioned between the detection chamber and the absorbing sponge.

15. A method for diagnosing a disease or disorder in a subject comprising:
(i) supplying a test sample derived from said subject to a reaction chamber, wherein said reaction chamber contains any buffer and primary analyte binding partners necessary for detection and/or quantitation of the analytes of interest, wherein detection of said analytes of interest indicates the presence of a disease or disorder and wherein the binding partner is capable of complexing with a detectable Quantum dot;
(ii) allowing for the required incubation period for recognition and binding of analytes to their primary binding partners to form a analyte/binding partner/Quantum dot complex;
(iii) transfer of the bioassay reaction mixture to a detection chamber wherein the detection chamber contains a secondary binding reagent, referred to as a capture reagent, immobilized on the surface of the detection chamber;
(iv) allowing for the required incubation period for recognition and binding of the analyte/binding partner/Quantum dot complex to the capture reagent;
(v) washing the detection chamber with a buffer to clear the detection chamber of unreacted components of the assay; and
(vi) detecting the presence and/or quantity of the bound analyte/binding partner/Quantum dot complexes wherein the detection of the presence of the analyte indicates the presence of a disease or disorder.

16. A diagnostic device for detecting the presence of an analyte in a liquid sample comprising:
an inlet port;
at least one reaction chamber;
a detection chamber;
a substrate body having a microfluidic channel structure for active transport of the liquid sample from the inlet port to at least one reaction chamber and the detection chamber;
an excitation source;
an optoelectronic device; and
an associated data receiving device;
wherein the device comprises primary analyte binding partners for binding with at least one analyte of the liquid sample in at least one reaction chamber, forming bound analyte complexes;
wherein the device further comprises a secondary binding reagent immobilized in the detection chamber for binding with the bound analyte complexes.

17. The diagnostic device of claim 16, wherein the associated data receiving device comprises a display.

18. The diagnostic device of claim 16, wherein the associated data receiving device comprises a electronics component capable of receiving data for transmission of the data to a display external to the diagnostic device.

19. The diagnostic device of claim 16, wherein the device further comprises quantum dots bound to the primary analyte binding partners.

20. The diagnostic device of claim 16, wherein the width and length of the device are approximately the same as the width and length of a typical credit card.
